(19) United States
(12) Patent Application Publication
(10) Pub. No.: US 2022/0017718 A1
(43) Pub. Date: Jan. 20, 2022

(54) A POLYMER COMPOSITE COMPRISING TUBULAR PARTICLES

(71) Applicant: BASF SE, Ludwigshafen am Rhein (DE)

(72) Inventors: Brad J. Martin, Wyandotte, MI (US); Mark Paul Kujawski, Grosse Pointe Wood, MI (US)

(73) Assignee: BASF SE, Ludwigshafen am Rhein (DE)

(21) Appl. No.: 17/309,634

(22) PCT Filed: Dec. 6, 2019
(86) PCT No.: PCT/EP2019/083978

§ 371 Date: Jun. 11, 2021

Related U.S. Application Data
(60) Provisional application No. 62/777,805, filed on Dec. 11, 2018.

(30) Foreign Application Priority Data
Jan. 23, 2019 (EP) 19153211.8

(51) Int. Cl. C08J 9/35; B29C 43/00; B29B 9/06; B29B 9/14; B29C 43/02; B29C 43/52; C08J 9/24

(52) U.S. Cl. CPC C08J 9/35; B29C 43/003; B29B 9/06; B29B 9/14; B29K 2067/04; B29C 43/02; B29C 43/52; C08J 9/24; B29C 43/006

(57) ABSTRACT

A polymer composite contains tubular particles, which contain at least one resin with fibres embedded. The tubular particles have an average length in the range of 0.5 mm to 60 mm and an average wall thickness in the range of 0.0005 mm to 30 mm, whereas the fibers have an average diameter in the range of 0.0005 mm to 5.0 mm. A process can be used to prepare the polymer composite containing tubular particles. The polymer composite can be used as a cushioning material, which can be formed into a cushioning article such as a shoe sole, a furniture cushion, a bed mattress, an automotive seat cushion, a flooring substrate, an outdoor/walking surface, a mat, a pad, and the like.

### FIELD OF THE DISCLOSURE

The presently claimed invention relates to a polymer composite containing a plurality of tubular particles. Particularly, the presently claimed invention relates to a polymer composite containing a plurality of tubular particles made of a resin with fibres embedded, which can be used as a cushioning material.

### BACKGROUND

Cushioning articles are generally made of either thermoplastic or thermoset polymer materials. Amongst the various polymers, polyurethanes are predominantly used to make cushion articles such as seat cushions, considering its excellent cushioning properties. Polyurethanes are used both in compact form and in foamed form, with a very wide density range. Polyurethanes can, for example, be present in the form of thermosets, elastomers, thermoplastic elastomers (TPUs), microcellular elastomers, integral foams, flexible foams, rigid foams or semirigid foams. However, there is a general consensus that the thermoset polyurethane foams are non-recyclable unlike thermoplastics such as thermoplastic polyurethane. Thus, hybrid materials comprising a matrix of polyurethane and foamed particles of thermoplastic polyurethane have also been developed in the past to use as a cushioning material.

Further, it is known that the polymer materials such as ethylene vinyl acetate (EVA), thermoset and thermoplastic polyurethane foams have been used in footwear manufacturing industries, particularly in making footwear cushions and midsoles. For instance, U.S. Pat. No. 6,759,443 discloses polyurethane foam shoe soles made by foaming a polyurethane made from vinyl polymer-grafted polyoxyalkylene polyether and U.S. Pat. No. 6,878,753 describes shoe soles and midsoles made of a thermoset polyurethane foam. It is important for cushioning materials to be resilient and durable, but thermoplastic elastomers providing such properties typically produce foams of higher density than is desirable in certain applications.

The thermoplastic foam particles that are used to make cushioning articles are combined loosely or bound together to form a connected network of particles. Binding of particles is achieved by using thermoset glues or using temperature and pressure along with the particles' inherent thermoplastic (melting) behavior to fuse them to one another. During the binding process, particles are usually placed in a mold under pressure and temperature to enable fusion in the mold and to form a shaped/contoured article (e.g. by steam chest crack molding). If too high temperature is used to bind the particles, shrinkage of the particles can occur producing an article smaller than the mold dimensions. WO2015017090 attempted to resolve aforesaid problem and disclosed a cushioning article comprising tubular particles of a thermoplastic elastomer foam and a non-foamed polymer disposed on an exterior surface of the thermoplastic elastomer foam.

However, it is found that the cushions/articles which are made by using purely thermoplastic elastomeric tubular particles still have limitations which include but are not limited to high in-place density and firm support. Thus, these cushions are not generally preferred by consumers. Furthermore, there are processing limitations at scalable production line speeds for such tubular particles that do not allow to achieve the desired lower densities.

Accordingly, there is a need to identify a more effective technology which can redefine the balance between support and comfort of a cushioning article by leveraging the anisotropic behaviour of tubular particles while allowing to achieve very low densities of the cushioning article.

Surprisingly, it was found that a polymer composite comprising tubular particles having an average length in the range of 0.5 mm to 60 mm and an average wall thickness in the range of 0.0005 mm to 5.0 mm can be effectively used for the preparation of a cushioning article that shows a desirable balance between support and comfort and a low density.

### SUMMARY OF THE DISCLOSURE

Hence, in one aspect, the presently claimed invention is directed to polymer composite comprising tubular particles comprising at least one resin with fibres embedded; wherein the tubular particles have an average length in the range of 0.5 mm to 60 mm and an average wall thickness in the range of 0.0005 mm to 30 mm; and wherein the fibers have an average diameter in the range of 0.0005 mm to 5.0 mm.

In another aspect, the presently claimed invention is directed a process of preparing the polymer composite comprising at least the steps of:
a) providing at least one resin and fibers;
b) co-extruding or pultruding the resin and the fibers to embed the fibers into the resin to obtain a tubular extrudate;
c) segmenting the tubular extrudate to form a plurality of tubular particles;
d) disposing the plurality of tubular particles in a mold; and
e) binding the plurality of tubular particles to form the polymer composite.

In another aspect, the presently claimed invention is directed to the use of a polymer composite as defined above as a cushioning material.

In still another aspect, the presently claimed invention is directed to a cushioning article comprising a polymer composite comprising a plurality of anisotropic tubular particles comprising at least one resin with fibres embedded; wherein the tubular particles have a length in the range of 0.5 mm to 60 mm, an average diameter in the range of 0.5 mm to 30.0 mm, and an average wall thickness in the range of 0.0005 mm to 5.0 mm; wherein the fibers have an average diameter in the range of 0.0005 mm to 5.0 mm; wherein the fibers are separated from each other using resin, oriented in one direction and aligned with each other; and the tubular particles are oriented and fused together.

### BRIEF DESCRIPTION OF THE FIGURES

Other advantages of the presently claimed invention will be readily appreciated, as the same becomes better understood by reference to the following detailed description when considered in connection with the accompanying drawings wherein:

FIG. 1 is a side cross-sectional view of one embodiment of a particle of the presently claimed invention;

FIG. 2 is a side cross-sectional view of one embodiment of a plurality of particles of the presently claimed invention; and

FIG. 3 is a side cross-sectional view of one embodiment of the composite of the presently claimed invention.

### DETAILED DESCRIPTION OF THE PRESENTLY CLAIMED INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It is being understood that various changes may be made in the function and arrangement of elements without departing from the spirit and scope of the invention as set forth in the appended claims. It is also to be understood that the terminology used herein, and the figure described herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well, i.e. a range of 1 to 10 implies that both 1 and 10 are included in the range. For the avoidance of doubt, the applicant shall be entitled to any equivalents according to the applicable law.

Reference throughout this specification to “one embodiment” or “an embodiment” means that a particular feature, structure or characteristic described in connection with the embodiment is included in at least one embodiment of the presently claimed invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to a person skilled in the art from the presently claimed invention, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments.

Also, it is noted that the individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but could have additional steps not discussed or included in a figure. Furthermore, not all operations in any particularly described process may occur in all embodiments. A process may correspond to a method, a function, a procedure, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof.

The presently claimed invention provides a polymer composite containing improved or modified tubular particles. The polymer composite of the presently claimed invention can be used as a cushioning material which can be formed into cushioning articles. The cushioning articles include, but are not limited to, shoe soles, furniture cushions, bed mattresses, automotive seat cushions, flooring substrates, outdoor walking/running surfaces or substrates, mats, pads, and the like.

The modification of the tubular particles is accomplished by co-extruding or pultruding tubular particles made of resin with one or more discrete fiber embedded in the resin. In one embodiment, the utilized fiber is very thin and has a modulus higher than that of the embedding resin.

In one embodiment, the polymer composite comprises tubular particles comprising at least one resin with fibres embedded; wherein the tubular particles have an average length in the range of 0.5 mm to 60 mm and an average wall thickness in the range of 0.0005 mm to 30 mm; and wherein the fibers have an average diameter in the range of 0.0005 mm to 5.0 mm.

In one embodiment, the average diameter of the tubular particles is in the range of 0.5 mm to 60 mm.

In another embodiment, the average diameter of the tubular particles is in the range of 2 mm to 10 mm.

In one embodiment, the tubular particles have a ratio of the average diameter to the average wall thickness in the range of 1:1 to 120000:1

In one embodiment, the polymer composite comprises tubular particles comprising at least one resin with fibres embedded; wherein the tubular particles have an average length in the range of 2 mm to 10 mm and an average wall thickness in the range of 0.1 mm to 1.3 mm; and wherein the fibers have an average diameter in the range of 0.0005 mm to 1.0 mm.

In one embodiment, the polymer composite comprises tubular particles comprising at least one resin with fibres embedded; wherein the tubular particles have an average length in the range of 2 mm to 10 mm, an average wall thickness in the range of 0.1 mm to 1.3 mm, and the average diameter in the range of 2 mm to 10 mm; and wherein the fibers have an average diameter in the range of 0.0005 mm to 1.0 mm.

In one embodiment, the polymer composite comprises tubular particles comprising at least one thermoplastic elastomer resin with polyamide-6 fibers embedded; wherein the tubular particles have an average length in the range of 2 mm to 10 mm, an average wall thickness in the range of 0.1 mm to 1.0 mm, and the average diameter in the range of 2 mm to 10 mm; and wherein the fibers have an average diameter in the range of 0.01 mm to 1.0 mm.

In one embodiment, the polymer composite comprises tubular particles comprising at least one thermoplastic elastomer resin with glass fibers embedded; wherein the tubular particles have an average length in the range of 2 mm to 10 mm, an average wall thickness in the range of 0.1 mm to 1.0 mm, and the average diameter in the range of 2 mm to 10 mm; and wherein the fibers have an average diameter in the range of 0.01 mm to 1.0 mm.

In one embodiment, there is provided a polymer composite comprising tubular particles comprising at least one resin with fibres embedded;

wherein the tubular particles have an average length in the range of 0.5 mm to 60 mm and an average wall thickness in the range of 0.0005 mm to 30.0 mm; and
wherein the fibers have an average diameter in the range of 0.0005 mm to 5.0 mm,
wherein the tubular particles have an average diameter in the range of 0.5 mm to 60.0 mm,
wherein the tubular particles have a loose bulk density in the range of 0.005 to 0.300 g/ml, and a molded density in the range of 0.010 to 0.16 g/ml.

In one embodiment, there is provided a polymer composite comprising tubular particles comprising at least one resin with fibres embedded;

wherein the tubular particles have an average length in the range of 0.5 mm to 60 mm and an average wall thickness in the range of 0.0005 mm to 30.0 mm; and
wherein the fibers have an average diameter in the range of 0.0005 mm to 5.0 mm,
wherein the tubular particles have an average diameter in the range of 0.5 mm to 60.0 mm,
wherein the tubular particles have a loose bulk density in the range of 0.005 to 0.300 g/ml, and a molded density in the range of 0.010 to 0.16 g/ml.
wherein, the tubular particles have a ratio of the average diameter to the average wall thickness in the range of 1:1 to 120000:1.

The fibers embedded in the resin include but are not limited to glass fibers, basalt fibers, carbon fibers, thermoplastic polymer fibers, thermoset polymer fibers, or any mixture thereof.

The terminology fibers refer to one or more fiber, filament, staple fiber, yarn, thread and the like.

In one embodiment the fiber is a continuous fiber embedded in the resin.

The terminology “embed/embedded” describes that the fibers are partially or fully embedded or impregnated or reinforced or attached or adhered to the wall of the tubular particles of resin. In one embodiment, the fibers are embedded at equidistance from each other in the wall of the tubular particles.

The fiber can be orientated in the walls of the tubular particles to deliver the “moment of inertia” effect. In one embodiment, the tubular particles exhibit anisotropic mechanical properties. The anisotropic behaviour of the tubular particles provides both cushion and support. The higher the modulus of the fiber material, the less material is needed to achieve the same “moment of inertia” effect. Keeping the high-modulus fibers very thin in diameter and separated from one another, allows the fibers to flex with minimal breakage when forces are applied to the tubular particles and thereby reducing the article's weight (density) without losing support and comfort.

The terminology “moment of inertia” in connection with particles refers to behaviour of tubular particles in which the particles remain flexible in the direction perpendicular to the fiber orientation, and more rigid in the direction parallel to the fiber orientation.

The terminology “anisotropic” in connection with particles refers to the physical properties that show different values, when measured in different directions. For example, the anisotropic tubular particle may require a particular amount of force to collapse the anisotropic tubular particle, when a force is applied to a side of the anisotropic tubular particle. The required amount of force in one direction may be different, when applied to another direction, e.g. the end of the anisotropic tubular particle to collapse the anisotropic tubular particle. The anisotropic particles are tubular and may have a solid or hollow structure.

In one embodiment, the tubular particles are hollow cylinders.

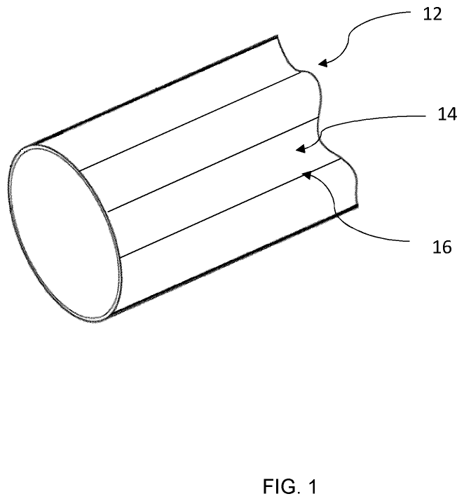

In one embodiment, the cross-section of the particles is circular, polygonal, or any other shape. In other words, the terminology “tubular” is not limited to a circular or polygonal cross section. The tubular particles are described herein below with the help of accompanying figures. In the illustrative FIGS. 1-3), the cross-sections are approximately circular. The tubular particles (12) may be described as hollow shapes having a length and a cross-section that may be of any shape. In other embodiments, the tubular particles (12) have curved shapes or bellowed shapes. Curving the tubular particles (12) can result in different properties, as will bellowing the tubular particles (12). The tubular particles (12) may be alternatively described as pipes, conduits, tubes, cylinders, etc. The use of tubular particles typically allows for lower bulk density of the composite/article to be achieved. Said differently, the geometry of the tubular particles typically allows for increased density reduction, for example, relative to a comparative composite that is formed without the technology of the presently claimed invention.

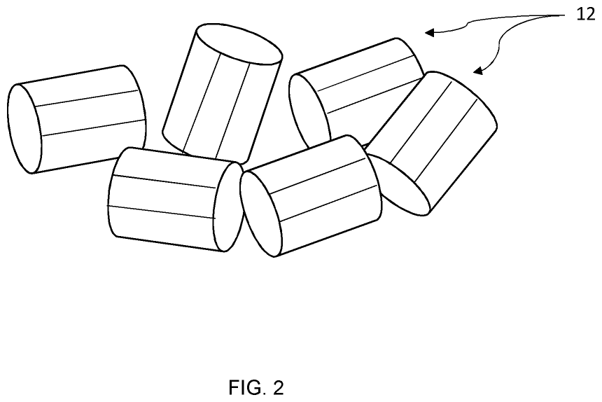

The polymer composite (10) includes a plurality of anisotropic tubular particles (12), herein also described as “particles (12)”, e.g. as shown in FIG. 2. The terminology “plurality” describes that the composite (10) includes multiple tubular particles (12), i.e., three or more.

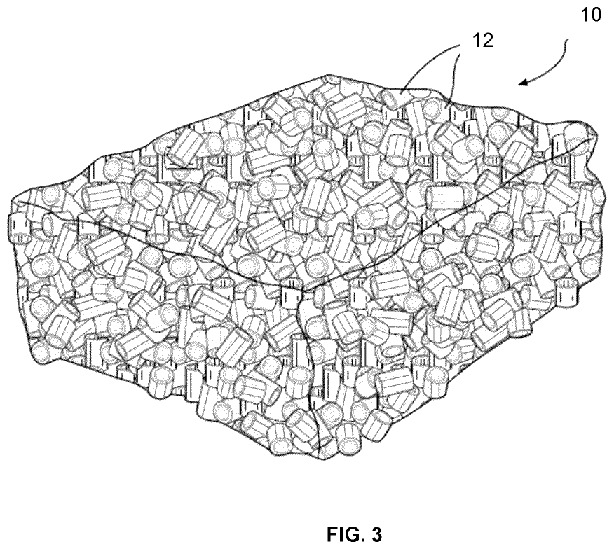

FIG. 3 illustrates that the tubular particles (12) are oriented in the composite (10), e.g. in one embodiment, the particles are oriented in three dimensions. In other words, the tubular particles (12) are not disposed unidirectionally or in any particular direction or directions in the composite (10). The tubular particles (12) are typically randomly oriented or dispersed in the composite (10) in the x, y, and z dimensions. Typically, a cross-section of the composite (10) would reveal no pattern to the orientation or dispersion of the tubular particles (12) in the composite (10).

The tubular particles (12) are typically fused together, but do not necessarily have to be “fused” so long as the composite has the aforementioned density. In one embodiment, some of the tubular particles (12) are fused together and others are not. Typically, if fused, the tubular particles (12) are fused using the method described below. The tubular particles (12) may be fused together at a plurality of points, e.g. along an edge of the tubular particles (12) or along or across an exterior surface (26) of the tubular particles (12). Alternatively, the tubular particles (12) may be fused together at one or more interfaces of the exterior layers of the various tubular particles (12). The tubular particles (12) may be melted together or otherwise adhered to one another, in any way, so long as the aforementioned density is achieved.

In accordance with the presently claimed invention, the tubular particles found to have a loose bulk density in the range of 0.005 to 0.300 g/ml, and a molded density in the range of 0.010 to 0.60 g/ml. In one preferred embodiment, the tubular particles found to have a loose bulk density in the range of 0.005 to 0.300 g/ml, and a molded density in the range of 0.010 to 0.300 g/ml. In another preferred embodiment, the tubular particles found to have a loose bulk density in the range of 0.005 to 0.150 g/ml, and a molded density in the range of 0.010 to 0.300 g/ml. In still another preferred embodiment, the tubular particles found to have a loose bulk density in the range of 0.005 to 0.150 g/ml, and a molded density in the range of 0.010 to 0.20 g/ml. In yet preferred embodiment, the tubular particles found to have a loose bulk density in the range of 0.005 to 0.150 g/ml, and a molded density in the range of 0.010 to 0.16 g/ml.

As used herein, the term loose bulk density refers to density of plurality of tubular particle in a loose, unbound form and it is expressed as a ratio of their weight to volume. The loose bulk density is determined by ASTM D1895 test method.

As used herein, the term molded density is the density of a plurality of tubular particles bound to one another to make a polymer composite. It is expressed as a ratio of its weight to volume. The molded density is determined by ASTM D792 test method.

The embedded fibers (16) in the tubular particles serve to increase the tensile modulus of the particles. The term tensile modulus is a measure of stiffness of a material. It defines relationship between stress (force per unit area) and strain (proportional deformation) in a material in the linear elasticity regimen of a uniaxial deformation. In one embodiment, the tubular particle has tensile modulus in the range of 13000 psi (89.6 Mpa) to 35000 psi (241 mPa), measured according to the procedures of ASTM D-638.

In one embodiment the tubular particles have an air flow of at least 2 ft³/min (0.000943895 m³/sec) as measured by ASTM D3574. In another embodiment, the tubular particles have an air flow of 2 (0.000943895 m³/sec) to 83 ft³/min (0.0391716 m³/sec). The term “air flow” refers to the volume of air which passes through a 1.0 inch (2.54 cm) thick 2 inch×2 inch (5.08 cm) square section of material at 125 Pa (0.018 psi) of pressure. Units are expressed in cubic decimetres per second and converted to standard cubic feet per minute. A representative commercial unit for measuring air flow is manufactured by TexTest AG of Zurich, Switzerland and identified as TexTest Fx3300. This measurement follows ASTM D 3574 Test G.

The resins and the fibers utilized for preparing the tubular particles are described herein below in details. The resin utilized for making the tubular particles according to the presently claimed invention may include foamed resins, non-foamed resins, or a combination thereof. In one embodiment of the presently claimed invention, the resin comprises thermoplastic polymer(s). In another embodiment, the resin comprises thermoset polymer(s). In still another embodiment the resin comprises a combination of thermoplastic polymer(s) and thermoset polymer(s).

The thermoplastic polymer may be selected from thermoplastic polyester elastomers (TPE), thermoplastic polyurethane elastomers (TPU), thermoplastic co-polyester elastomers (TPC), thermoplastic styrenic elastomers (TPS), thermoplastic polyamides (TPA), thermoplastic vulcanates (TPV), thermoplastic polyolefins (TPO), and any combinations thereof.

In one embodiment, the thermoplastic polymer is a thermoplastic polyurethane foam.

The thermoplastic polyurethane may be further defined as a polyether thermoplastic polyurethane, a polyester thermoplastic polyurethane, or a combination of a polyether thermoplastic polyurethane and a polyester thermoplastic polyurethane, i.e. the non-foamed and/or the foamed thermoplastic polyurethane may be further defined as including or being the reaction product of an isocyanate and a polyether polyol, a polyester polyol, an aliphatic or olefinic polyol or a combination of these polyols. Alternatively, the non-foamed and/or the foamed thermoplastic polyurethane may be further defined as a multi-block copolymer produced from a poly-addition reaction of an isocyanate with a linear polymeric glycol (e.g. having a weight average molecular weight of from 500 to 8,000 g/mol), low molecular weight diol (e.g. having a weight average molecular weight of from 50 to 600 g/mol), and or/polyol. Typically, the non-foamed and/or foamed thermoplastic polyurethanes can be obtained by varying a ratio of hard segments and soft segments, as described herein. Physical properties such as shore Hardness, along with modulus, load-bearing capacity (compressive stress), tear strength, and specific gravity, typically increase as a ratio of hard segments to soft segments increases.

In one embodiment, the non-foamed and/or the foamed thermoplastic polyurethane is a polyester thermoplastic polyurethane and includes the reaction product of a polyester polyol, an isocyanate component, and a chain extender. Suitable polyester polyols are typically produced from a reaction of a dicarboxylic acid and a glycol having at least one primary hydroxyl group. Suitable dicarboxylic acids include, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Glycols that are suitable for use in producing the polyester polyols include, but are not limited to, ethylene glycol, butylene glycol, hexanediol, bis(hydroxymethylcyclohexane), 1,4-butanediol, diethylene glycol, 2-methyl-propanediol, 3-methyl-pentanediol, 2,2-dimethyl propylene glycol, 1,3-propylene glycol, and combinations thereof.

In another embodiment, the non-foamed and/or the foamed thermoplastic polyurethane is a polyester thermoplastic polyurethane and includes the reaction product of a suitable chain extender, an isocyanate component, and a polymeric polyol. Suitable chain extenders include, but are not limited to, diols including ethylene glycol, propylene glycol, butylene glycol, 1,4-butanediol, butenediol, butynediol, 2-ethyl-1,3-hexanediol, xylylene glycols, amylene glycols, 1,4-phenylene-bis-beta-hydroxy ethyl ether, 1,3-phenylene-bis-beta-hydroxy ethyl ether, bis-(hydroxy-methyl-cyclohexane), hexanediol, and thiodiglycol, diamines including ethylene diamine, propylene diamine, butylene diamine, hexamethylene diamine, cyclohexalene diamine, phenylene diamine, tolylene diamine, xylylene diamine, 3,3′-dichlorobenzidine, 3,3′-and dinitrobenzidine, alkanol amines including ethanol amine, aminopropyl alcohol, 2,2-dimethyl propanol amine, 3-aminocyclohexyl alcohol, and p-aminobenzyl alcohol, and combinations thereof. Specific examples of suitable polyester thermoplastic polyurethanes that can be used in this invention include, but are not limited to, Elastollan® 600, 800, B, C, and S Series polyester thermoplastic polyurethanes that are commercially available from BASF Corporation.

In a further embodiment, the non-foamed and/or the foamed thermoplastic polyurethane is a polyether thermoplastic polyurethane and includes the reaction product of a polyether polyol, an isocyanate component, and a chain extender. Suitable polyether polyols include, but are not limited to, polytetramethylene glycol, polyethylene glycol, polypropylene glycol, and combinations thereof. In yet another embodiment, the non-foamed and/or the foamed thermoplastic polyurethane is a polyether thermoplastic polyurethane and includes the reaction product of a chain extender and an isocyanate component. It is to be understood that any chain extender known in the art can be used by one of skill in the art depending on the desired properties of the thermoplastic polyurethane. Specific examples of suitable polyether thermoplastic polyurethanes that may be used in this invention include, but are not limited to, Elastollan® 1000, 1100 and 1200 Series polyether thermoplastic polyurethanes that are commercially available from BASF Corporation.

In a further embodiment, the non-foamed and/or the foamed thermoplastic polyurethane is an aliphatic or olefinic thermoplastic polyurethane and includes the reaction product of an aliphatic or olefinic thermoplastic polyol, an isocyanate component and a chain extender. Suitable polyether polyols include, but are not limited to, hydrogenated polybutadiene or non-hydrogenated polybutadiene and combinations thereof or in combination with polyester and/or polyether polyol. It is to be understood that any chain extender known in the art can be used by one of skill in the art depending on the desired properties of the thermoplastic polyurethane.

Typically, the polyether, polyester, aliphatic or olefinic polyols used to form the non-foamed and/or the foamed thermoplastic polyurethane have a weight average molecular weight of from 600 to 3,000 g/mol. However, the polyols are not limited to this molecular weight range. In one embodiment, starting materials used to form the non-foamed and/or the foamed thermoplastic polyurethane (e.g., a linear polymeric glycol, a low molecular weight diol, and/or a polyol) have average functionalities of approximately 2. For example, any pre-polymer or monomer can have 2 terminal reactive groups to promote formation of high molecular weight linear chains with no or few branch points in the non-foamed and/or the foamed thermoplastic polyurethane.

The isocyanate component that is used to form the non-foamed and/or the foamed thermoplastic polyurethane typically includes, but is not limited to, isocyanates, diisocyanates, polyisocyanates, and combinations thereof. In one embodiment, the isocyanate component includes an n-functional isocyanate. In this embodiment, n is a number typically from 2 to 5, more typically from 2 to 4, still more typically of from 2 to 3, and most typically about 2. It is to be understood that n may be an integer or may have intermediate values from 2 to 5. The isocyanate component typically includes an isocyanate selected from the group of aromatic isocyanates, aliphatic isocyanates, and combinations thereof. In another embodiment, the isocyanate component includes an aliphatic isocyanate such as hexamethylene diisocyanate (HDI), dicyclohexyl-methyl-diisocyanate (H12MDI), isophorone diisocyanate, and combinations thereof. If the isocyanate component includes an aliphatic isocyanate, the isocyanate component may also include a modified multivalent aliphatic isocyanate, i.e. a product which is obtained through chemical reactions of aliphatic diisocyanates and/or aliphatic polyisocyanates. Examples include, but are not limited to, ureas, biurets, allophanates, carbodiimides, uretonimines, isocyanurates, urethane groups, dimers, trimers, and combinations thereof. The isocyanate component may also include, but is not limited to, modified diisocyanates employed individually or in reaction products with diethylene glycols, dipropylene glycols, polyoxyethylene glycols, polyoxypropylene glycols, polyoxypropylenepolyoxethylene glycols, polyesterols, polycaprolactones, and combinations thereof.

Alternatively, the isocyanate component can include an aromatic isocyanate. If the isocyanate component includes an aromatic isocyanate, the aromatic isocyanate typically corresponds to the formula R′(NCO)_{z} wherein R′ is aromatic and z is an integer that corresponds to the valence of R′. Typically, z is at least two. Suitable examples of aromatic isocyanates include, but are not limited to, tetramethylxylyl diisocyanate (TMXDI), 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1 -nitrobenzene, m-phenylene diisocyanate,/phenylene diisocyanate, 2,4-toluene diisocyanate, 2,6-toluene diisocyanate, mixtures of 2,4- and 2,6-toluene diisocyanate, 1,5-naphthalene diisocyanate, l-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-di phenyl methane diisocyanate, 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof. Alternatively, the aromatic isocyanate may include a triisocyanate product of m-TMXDI and 1,1,1-trimethylolpropane, a reaction product of toluene diisocyanate and 1,1,1-trimethyolpropane, and combinations thereof. In one embodiment, the isocyanate component includes a diisocyanate selected from the group of methylene diphenyl diisocyanates, toluene diisocyanates, hexamethylene diisocyanates, H12MDIs, and combinations thereof. The isocyanate component can also react with the polyol and/or chain extender in any amount, as determined by one skilled in the art.

Thermoplastic polyurethane elastomers (e.g. foamed or non-foamed) may also be described herein simply as TPUs, thermoplastic polyurethanes, or TPE-U's. Thermoplastic polyurethane elastomers typically include linear segmented polymeric blocks including hard and soft segments. Without intending to be bound by any particular theory, it is believed that the soft segments are of low polarity and form an elastomer matrix which provides elastic properties to the thermoplastic polyurethane. The hard segments are believed to be shorter than the soft segments, to be of higher polarity, and act as multifunctional tie points that function both as physical crosslinks and reinforcing fillers. The physical crosslinks are believed to disappear when heat is applied, thus allowing the thermoplastic polyurethanes to be used in the variety of processing methods.

### Thermoplastic Polyester Elastomers:

The thermoplastic elastomer foam may alternatively be a thermoplastic polyester elastomer, also known as a TPC. Thermoplastic elastomers are may also be described as thermoplastic rubbers and are typically a class of copolymers or a physical mix of polymers (e.g. a plastic and a rubber) which have both thermoplastic and elastomeric properties. Non-limiting examples of thermoplastic polyester elastomers are Amitel® from DSM and Hytrel® from DuPont.

Thermoplastic Styrenic Elastomers:

The thermoplastic elastomer (foam) may alternatively be a thermoplastic styrenic elastomer, also known as a styrol, styrenic block copolymer with ethylene, propylene, butadiene, isoprene units, or a TPS. Thermoplastic styrenic elastomers are typically based on A-B-A type block structure where A is a hard phase and B is an elastomer. Non-limiting examples of thermoplastic styrenic elastomers are Kraton® D and Kraton® G.

Thermoplastic Vulcanizate Elastomers:

The thermoplastic elastomer (foam) may alternatively be a thermoplastic vulcanate elastomer, also known as a TPV. A non-limiting example of a thermoplastic vulcanate elastomer is Santoprene® from ExxonMobil.

Thermoplastic Polvamide Elastomers:

The thermoplastic elastomer (foam) may alternatively be a thermoplastic polyamide elastomer, also known as a TP A. A non-limiting example of a thermoplastic polyamide elastomer is Vestamid® E from Evonik.

Thermoplastic Polyolefin Elastomers:

The thermoplastic elastomer (foam) may alternatively be a thermoplastic polyolefin elastomer, also known as a TPO. A non-limiting example of a thermoplastic polyolefin elastomer is Engage from Dow.

The thermoset polymer may be chosen from polyester(s), polyamide(s), epoxy resin(s), vinyl ester(s), melamine formaldehyde(s), urea formaldehyde(s), phenolic resin(s), silicone(s), polyurethane(s), vulcanized rubber(s), polyurea, phenol formaldehyde(s), duroplast, melamine resin(s), benzoxazine, furan resin(s), cyanate ester(s), thiolytes, diallyl-phthalate(s), or any combination thereof.

In one embodiment of the presently claimed invention, the fibers can be selected from the group of thermoplastic polyester elastomer (TPE) fibers, thermoplastic styrenic elastomer (TPS) fibers, thermoplastic polyamide (TPA) fibers, thermoplastic vulcanate (TPV) fibers, thermoplastic polyolefin (TPO) fibers, or any combinations thereof.

In another embodiment of the presently claimed invention, the fibers can be selected from the group of polyester fibers, polyamide fibers, epoxy resin fibers, vinyl ester fibers, melamine formaldehyde fibers, urea formaldehyde fibers, phenolic resin fibers, silicone fibers, polyurethane fibers, vulcanized rubber fibers, polyurea fibers, phenol formaldehyde(s) fibers, duroplast fibers, melamine resin fibers, benzoxazine fibers, furan resin fibers, cyanate ester fibers, thiolyte fibers, diallyl-phthalate fibers, or any combination thereof.

In one illustrative embodiment, the tubular particles (12) include a thermoplastic elastomer foam (14) with fibers (16) embedded on an exterior surface of the thermoplastic elastomer foam (14).

### Thermoplastic Elastomer Foam:

The thermoplastic elastomer foam (14) is not particularly limited so long as it is a foam. However, the thermoplastic elastomer foam (14) is typically formed from a thermoplastic elastomer that is not foamed. In one embodiment, and as described below, the thermoplastic elastomer foam (14) is typically foamed during extrusion of a non-foamed thermoplastic elastomer. For example, a non-foamed thermoplastic elastomer may be provided to an extruder (e.g. in pellet form) and then, during the process of extrusion, may be foamed to form the thermoplastic elastomer foam (14). Additional process steps may also be useful such as adding expandable microspheres, adding blowing agents, e.g. NaHCO₃ or citric acid, or adding gas, e.g. CO₂, N₂, or Ar, by injection into a melt. Combinations of these steps may also be used. As described herein, the terminology “thermoplastic elastomer” and “thermoplastic elastomer foam (14)” may be used interchangeably in various non-limiting embodiments.

In an embodiment, the thermoplastic elastomer foam (14) is produced using a non-foamed thermoplastic elastomer having a durometer from Shore 40A to 83D, as determined using DIN ISO 7619-1. In an embodiment, the non-foamed thermoplastic elastomer used to form the thermoplastic elastomer foam (14) has a durometer from 40A to 83D, from 60A to 70D, or from 80A to 95 A, as determined using DIN ISO 7619-1. The thermoplastic elastomer foam (14) itself typically has a density from 0.1 to 0.9 from 0.15 to 0.55, from 0.2 to 0.5, from 0.25 to 0.45, from 0.3 to 0.4, from 0.3 to 0.35, or from 0.35 to 0.4, g/cc (or g/ml).

Method of Forming the Polymer Composite:

The presently claimed invention is also directed to a process for preparing the polymer composite (10). In one embodiment, the process for preparing the polymer composite comprising at least the steps of:
providing at least one resin and fibers;
co-extruding or pultruding the resin and the fibers to embed the fibers into the resin to obtain a tubular extrudate;
segmenting the tubular extrudate to form a plurality of tubular particles;
disposing the plurality of tubular particles in a mold; and binding the plurality of tubular particles to form the polymer composite.

In one illustrative embodiment, the process involves providing the resin and the aforementioned fibers, as described herein. The process further includes the step of co-extruding or pultruding the resin and the fibers (16) to form a tubular extrudate (22). In one embodiment the resin used is a non-foamed thermoplastic elastomer which is foamed during co-extrusion (thereby forming the thermoplastic elastomer foam (14)). The fibers get embedded onto/into the exterior surface of the resin or the thermoplastic elastomer. The step of co-extruding is not particularly limited and may be as known in the art. Said differently, the step of co-extruding may include one or more sub-steps, temperatures, conditions, etc., that are known in the art.

In another embodiment the resin used is a thermoplastic elastomer which is not foamed during co-extrusion (thereby forming the thermoplastic elastomer (14)).

As used herein, the term extrusion refers to pushing the resin through an extrusion die.

As used herein, the term pultrusion refers to drawing or pulling the fibers and/or resin with fibers continuously through an impregnating bath or pultrusion die.

For example, in various embodiments, the step of co-extruding utilizes the following parameters which may be modified as understood by those of skill in the art:

Die Type: Crosshead; extruder 1 (1-1/2″ dia.); Zone 1—340° F.; Zone 2—360° F.; Zone 3—370° F.; Zone 4—370° F.; Clamp—370° F.; Adapter—370° F.; Head Pressure—4000 psi(27.6 MPa); Screw RPM—12.5, Screw Torque—18.5%; Extruder 2 (¾″ dia.); Zone 1—275° F.; Zone 2—320° F.; Zone 3—340° F.; Clamp—340 F; Adapter—340° F.; Head Pressure—3800 psi(26.2 MPa); Screw RPM—15; Screw Torque—31.6%; Die Head—370 F; Die—370 F; Take Off Motor 230 RPM; Rate Indicator 21.3.

Alternatively, one or more parameters of co-extrusion may be as described in the Examples.

The method also includes the step of segmenting the tubular extrudate (22) to form the plurality of the tubular particles (12). The step of segmenting is typically further defined as cutting or chopping but is not particularly limited.

The method further includes the step of disposing the plurality of particles (12) in a mold. The tubular particles (12) are typically disposed in the mold in a random fashion, e.g. by pouring into the mold. Pouring into a mold typically allows for the random or three-dimensional orientation of the tubular particles (12) in the final product. In another embodiment, the tubular particles (12) are either (1) poured manually “by hand” into a mold, or (2) injected into a mold using an air conveyance system. Typically, the mold is filled while being in an open position, allowing particles to “overfill” the mold. After the mold is closed, the particles are typically forced together which promotes increased surface area contact and thereby increased adhesion.

The method also includes binding the tubular particles. In one embodiment binding includes heating the plurality of tubular particles (12) to fuse together and form the composite (10), e.g. such that the plurality of tubular particles (12) are randomly oriented in the composite (10). The step of heating is not particularly limited and may include heating by electricity, gas, steam, etc. In one embodiment, the step of heating is further defined as heating the tubular particles (12) with steam, e.g. as in a steam chest crack molding process. In another embodiment, the step of heating (and/or the entire method) may be further defined as a steam chest crack molding process. The particular steps may be as known in the art and/or as described above.

In one embodiment, the method includes loading the mold with the tubular particles (12) and feeding steam to the tubular particles (12) in the mold. The feeding of steam heats the tubular particles (12). The method of the presently claimed invention may include one or more steps, components, conditions, or processing parameters as described in US 2013/0291409, which is expressly incorporated herein in its entirety.

The extent to which the tubular particles (12) are compressed in the mold may influence the density and the strength of the resultant composite (10). This is manipulated by changing the amount of particles fed into the mold. Particles are fed with the mold in an open position (therefore its volume during feeding is higher than when it is fully closed). Increasing the openness of the mold increases the amount of material fed into the mold. More particles in the mold results in higher molded densities and more extensive compression of the tubular particles. Mold design also plays a role in the compression of particles.

In still another embodiment, the method may include the step of closing the mold and pre-treating the mold with steam. The method may also include the step of cooling the mold with water and/or air that are fed through the mold. Thus, the composite (10) and/or the tubular particles (12) may be cooled indirectly via the mold. In certain embodiments, the duration of the method is about 3-15 minutes. The duration may alternatively be about 3-6 minutes for less elaborate methods. Still further, the method may have a duration of longer than 15 minutes.

The presently claimed invention also provides the extrudate or the tubular structure (prior to chopping or segmenting) by itself independent of any particles or any composite/article. Similarly, the presently claimed invention also provides the plurality of particles by themselves, independent from any extrudate or tubular structure or composite or article. The extrudate or tubular structure may be any as described above. Similarly, the plurality of particles may be any as described above.

In another embodiment, the binding includes adding of at least one adhesive to bind the particles together. The particles are covered by or coated with a commercially available adhesive(s) and pressed together in a mold to form a desired composite. Adhesives refer to materials that are applied as a low-viscosity liquid and transform into a strong, tough solid that bonds two surfaces together. The adhesive includes, but is not limited to polyvinyl alcohol resins, acrylic resins, vinyl acetate-based resins, polyurethane-based resins, silicon-based resins, polyether-based resins, polyamide-based resins, and the like.

In one embodiment, the polymer composite is thermoplastic based and is melt-reprocessable which enables recycling.

The presently claimed invention further provides the polymer composite that is further defined as a cushioning material. In another aspect, the presently claimed invention provides a cushioning article made from the cushioning material. In one embodiment, the cushioning article contains a polymer composite made of tubular particles comprising at least one resin with fibres embedded as described herein above. The fibers are separated from each other using the resin and are oriented in one direction and aligned with one another and the anisotropic tubular particles are oriented and fused together in the article. In one embodiment, the anisotropic tubular particles are randomly oriented. The exemplary cushioning articles include but are not limited to shoe soles, furniture cushions, bed mattresses, automotive seat cushions, flooring substrates, outdoor walking or running surfaces, mats, pads and the like. The shoe sole may have one or more dimensions, attributes, or components as described in US 2013/0291409, which is expressly incorporated herein in its entirety.

In another aspect the presently claimed invention provides use of a polymer composite as a cushioning material.

In another aspect of the presently claimed invention the cushioning material is formed into a cushioning article.

### EXAMPLES

Aspects of the present invention are more fully illustrated by the following examples, which are set forth to illustrate certain aspects of the present invention and are not to be construed as limiting thereof.

A series of composites were formed according to the presently claimed invention. More specifically, a non-foamed thermoplastic elastomer with fibers embedded was prepared. The thermoplastic elastomer and the fibers were co-extruded to form a tubular extrudate in which the thermoplastic elastomer gets the fiber embedded. The thermoplastic elastomer encapsulates one or more discrete fibers, thereby forming fiber-reinforced thermoplastic tubular particles. The fibers used were continuous fibers. The tubular extrudate was then segmented to form a plurality of anisotropic tubular particles. The plurality of anisotropic tubular particles was then disposed in a mold and heated to form the polymer composite. After formation, the composite was evaluated to determine various parameters such as molded density, ultimate breaking strength, breathability, etc.

Example 1: A first composite was formed by extruding Elastollan 1190A10 as the thermoplastic elastomer (resin, having a Shore hardness of 90A) and polyamide-6 (PA6) as the fiber. The thermoplastic elastomer was extruded and foamed with a blowing agent: Elastollan Konz V2894 at 6% loading. The thermoplastic elastomer has a foamed specific gravity of approximately 0.6 gram/mL. The tubing has an average outer diameter of 8-mm. The PA6 fibers have an average diameter of 0.18-mm. The thermoplastic elastomer has an average wall thickness of 0.45-mm. The plurality of anisotropic particles has a loose bulk density of 0.07 g/mL. The plurality of anisotropic particles was molded to form composite having a density from 0.07 g/mL to 0.10 g/mL.

Example 2: A second composite was formed using Elastollan 1190A10 as the thermoplastic elastomer and polyamide-6 (PA6) as the fiber. The thermoplastic elastomer and the fiber were pultruded. The tubing has an average outer diameter of 5-mm. The PA6 fibers have an average diameter of 0.18-mm. The thermoplastic elastomer has an average wall thickness of 0.35-mm. The plurality of anisotropic particles has a loose bulk density of 0.13 g/mL. The plurality of anisotropic particles is molded to form composites having a density from 0.13 g/mL to 0.16 g/mL.

Example 3: A third composite was formed by extruding Elastollan 1180A10 as the thermoplastic elastomer (resin, having a Shore hardness of 80A) and glass fibers as the fiber. The tubing has an average outer diameter of 4-mm. The glass fibers have an average diameter of 0.18-mm. The thermoplastic elastomer has an average wall thickness of 0.20-mm. The plurality of anisotropic particles has a loose bulk density of 0.11 g/mL. The plurality of anisotropic particles is molded to form composite having a density from 0.11 g/mL to 0.14 g/m L.

Example 4: Comparative example (US2018072861): A first article is formed using Elastollan® 1180A10 as the thermoplastic elastomer (having a Shore hardness of 80A) and Elastollan® 880A13N as the exterior non-foamed polymer which includes 0.25 weight percent of barium titanate as the additive. The thermoplastic elastomer is extruded and foamed with a combination of blowing agents: Elastollan Konz V2894 at 3% loading and Elastollan Konz V2893 at 3% loading. The thermoplastic elastomer has a foamed specific gravity of approximately 0.4 gram/mL. The tubing has an average outer diameter of 0.125 inches. The exterior polymer has an average wall thickness of 0.004 inches. The foamed thermoplastic elastomer has an average wall thickness of 0.030 inches. The plurality of anisotropic particles has a loose bulk density of 0.16 gram/mL. The plurality of anisotropic particles are exposed to microwave energy to selectively heat the non-foamed polymer to its softening temperature prior to the thermoplastic elastomer foam reaching its softening temperature and form the article such that the plurality of anisotropic tubular particles are randomly oriented in the article. Various articles are formed having a density from 0.20 to 0.26 gram/mL.

Example 5: Comparative example (US2018072861): A second article is formed using Elastollan® 1190A10 as the thermoplastic elastomer (having a Shore hardness of 90A) and Elastollan® 880A13N as the exterior non-foamed polymer which includes 0.25 weight percent of barium titanate as the additive. The thermoplastic elastomer is extruded and foamed with a combination of blowing agents: Elastollan Konz V2894 at 3% loading and Elastollan Konz V2893 at 3% loading. The thermoplastic elastomer has a foamed specific gravity of approximately 0.4 gram/mL. The tubing has an average outer diameter of 0.125 inches. The exterior polymer has an average wall thickness of 0.004 inches. The foamed thermoplastic elastomer has an average wall thickness of 0.030 inches. The plurality of anisotropic particles has a loose bulk density of 0.16 gram/mL. The plurality of anisotropic particles are exposed to microwave energy to selectively heat the non-foamed polymer to its softening temperature prior to the thermoplastic elastomer foam reaching its softening temperature and form the article such that the plurality of anisotropic tubular particles are randomly oriented in the article. Various articles are formed having a density from 0.20 to 0.26 gram/mL.

It is found that incorporating fibers helps to change the anisotropic performance of the tube particle. Fibers of higher modulus than the resin matrix will increase the moment of inertia of a vertically aligned tube, making it a stiffer particle. Thus, it is possible to either (a) increase the stiffness of a molded article at a given density, OR (b) maintain the stiffness of a molded article at a lower density.

In various embodiments, the density of the tubular particles can be minimized as the performance of the particle may depend on the modulus achieved from the fiber and the wall thickness. The presently claimed invention may allow for formation of lower density composites/articles while maintaining performance (e.g. energy absorption and return). Lower densities may allow the particles to better compete with traditional thermoset foams commonly seen in furniture cushions, mattresses, and automotive seating. A thermoplastic elastomer is also considered more “recycle friendly” than a thermoset polymer.

1. A polymer composite, comprising:
tubular particles comprising at least one resin with fibers embedded;
wherein the tubular particles have an average length in the range of 0.5 mm to 60 mm and an average wall thickness in the range of 0.0005 mm to 30.0 mm; and
wherein the fibers have an average diameter in the range of 0.0005 mm to 5.0 mm.

2. The polymer composite according to claim 1, wherein the tubular particles exhibit anisotropic mechanical properties.

3. The polymer composite according to claim 1, wherein a shape of the cross section of said tubular particles is selected from the group consisting of a circular shape, a polygonal shape, and any combination thereof; and
wherein said tubular particles have a hollow structure.

4. The polymer composite according to claim 1, wherein the tubular particles have an average diameter in the range of 0.5 mm to 60.0 mm.

5. The polymer composite according to claim 1, wherein the tubular particles have a ratio of average diameter to average wall thickness in the range of 1:1 to 120000:1

6. The polymer composite according to claim 1, wherein the tubular particles have a loose hulk density in the range of 0.005 to 0.300 g/ml, and a molded density in the range of 0.010 to 0.60 g/m/l,, and a tensile modulus of 13000 psi (89.6MPa) to 35000 psi (241 MPa.).

7-8. (canceled)

9. The polymer composite according to claim 1, wherein the at least one resin comprises a foamed resin, a non-foamed resin, or a combination thereof.

10. The polymer composite according to claim 1, wherein the at least one resin comprises a thermoplastic polymer, a thermoset polymer, or a combination thereof

11. The polymer composite according to claim 10, wherein the thermoplastic polymer is a thermoplastic polyurethane foam.

12. The polymer composite according to claim 11, wherein the thermoplastic polyurethane foam is a foamed reaction product of:
a polyether polyol, an isocyanate component, and a chain extender; or
a polyester polyol, an isocyanate component, and a chain extender, or
a polyolefin polyol, an isocyanate component, and a chain extender.

14. (canceled)

15. The polymer composite according to claim 10, wherein the thermoplastic polymer comprises a thermoplastic polyester elastomer (TPE), a thermoplastic styrenic elastomer (TPS), a thermoplastic polyamide (TPA), a thermoplastic vulcanite (TPV), a thermoplastic polyolefin (TPO), or any combination thereof.

16. The polymer composite according to claim 10, wherein the thermoset polymer comprises polyester(s), polyamide(s), epoxy resin(s), vinyl ester(s), melamine formaldehyde(s), urea formaldehyde(s), phenolic resin(s), silicone(s), polyurethane(s), vulcanized rubber(s), polyurea, phenol formaldehyde(s), duroplast, melamine resin(s), benzoxazine, furan resin(s), cyanate ester(s), thiolytes, diallyl-phthalate(s), or any combination thereof.

17. The polymer composite according to claim 1, wherein the fibers are selected from the group consisting of glass fibers, basalt fibers, carbon fibers, thermoplastic polymer fibers, thermoset polymer fibers, and any mixture thereof.

18. The polymer composite according to claim 1, wherein the tubular particle has a tensile modulus in the range of 13000 psi (89.6MPa) to 35000 psi (241 MPa), measured according to the procedures of ASTM D-638.

19. The polymer composite according to claim 1, wherein said fibers comprise thermoplastic polyester elastomer (TPE) fibers, thermoplastic styrenic elastomer (TPS) fibers, thermoplastic polyamide (TPA) fibers, thermoplastic vulcanate (TPV) fibers, thermoplastic polyolefin (TPO) fibers, or any combination thereof.

20. The polymer composite according to claim 1, wherein said fibers comprise polyester fibers, polyamide fibers, epoxy resin fibers, vinyl ester fibers, melamine formaldehyde fibers, urea formaldehyde fibers, phenolic resin fibers, silicone fibers, polyurethane fibers, or any combination thereof.

21. The polymer composite according to claim 1, wherein the resin and the fibers both comprise a thermoplastic polymer, a thermoset polymer, or a mixture of a thermoplastic polymer and a thermoset polymer.

22. The polymer composite according to claim 1, wherein the polymer composite comprises at least one adhesive,
wherein the adhesive comprises a polyvinyl alcohol resin, an acrylic resin, a vinyl acetate-based resin, a polyurethane-based resin, a silicon-based resin, a polyester-based resin a polyamide-based resin, or any combination thereof.

23. (canceled)

24. The polymer composite according to claim 1, wherein the polymer composite has an air flow of at least 2 ft³/min (0.000943895 m³/sec), measured according to the procedures of ASTM D 3574 Test G.

25. (canceled)

26. A process for preparing the polymer composite according to claim 1, the process at least comprising:
a) providing at least one resin and fibers;
b) co-extruding or pultruding the resin and the fibers to embed the fibers into the resin, to obtain a tubular extrudate;
c) segmenting the tubular extrudate, to form a plurality of tubular particles;
d) disposing the plurality of tubular particles in a mold; and
e) binding the plurality of tubular particles, to form the polymer composite.

27. The process according to claim 26, wherein the binding comprises steam heating the plurality of tubular particles to fuse together or adding at least one adhesive to bind the plurality of tubular particles.

28-39. (canceled)

40. A cushioning material, comprising the polymer composite according to claim 1.

41. A cushioning article, formed from the cushioning material according to claim 40,
wherein the cushioning article is selected from the group consisting of a shoe sole, a furniture cushion, a bed mattress, an automotive seat cushion, a flooring substrate, an outdoor walking/running surface, a mat, and a pad.

42. (canceled)

43. A cushioning article, comprising:
a polymer composite comprising tubular particles comprising at least one resin with fibers embedded:
wherein the tubular particles have a length in the range of 0.5 mm to 60 mm, an average diameter in the range of 0.5 mm to 60.0 mm, and an average wall thickness in the range of 0.0005 mm to 5.0 mm;
wherein the fibers have an average diameter in the range of 0.0005 mm to 5.0 mm;
wherein the fibers are separated from each other using resin, oriented in one direction and aligned with each other; and
wherein the tubular particles are randomly oriented and fused together.

44. (canceled)
